(19) United States
(12) Patent Application Publication
(10) Pub. No.: US 2003/0144962 A1
(43) Pub. Date: Jul. 31, 2003

(54) Digital information recording card

(76) Inventor: Nobuhiko Kobayashi, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/123,161

(22) Filed: Apr. 17, 2002

(30) Foreign Application Priority Data
Jan. 31, 2002 (JP) 2002-24687

(51) Int. Cl. G06F 17/60

(52) U.S. Cl. 705/57

(57) ABSTRACT

A digital greeting card includes a ROM portion and an R portion. The ROM portion includes a first sub portion and a second sub portion. The first sub portion stores signals representing different types of contents. The second sub portion stores a computer program for reproducing the different types of contents and recording information. In the R portion, segments can be sequentially provided according to the computer program. Each of the segments stores a signal designating at least one selected from the different types of contents in accordance with user's request and a signal representative of at least one of (1) a picture, (2) a character sequence, and (3) a sound designed by the user.

### BACKGROUND OF THE INVENTION

1. Field of the Invention

This invention relates to a digital information recording card which can be used as a digital greeting card. Also, this invention relates to a method of making a digital greeting card. In addition, this invention relates to a digital greeting card sales apparatus. Furthermore, this invention relates to a method of selling digital greeting cards on a chain basis.

2. Description of the Related Art

Electronic greeting cards can be transmitted via the Internet.

In general, each electronic greeting card has a template portion and a writable portion. The template portion indicates, for example, a template picture and a template greeting sentence. The writable portion can be designed in accordance with user's request. For example, the writable portion indicates user's message to be transmitted.

An Internet-based delivery system for electronic greeting cards includes a server which stores data representing various basic electronic greeting cards forming templates respectively. An electronic greeting card is transmitted as follows. A sender side accesses the server via the Internet, and selects one among the basic electronic greeting cards. The sender side registers a message in the server. At that time, a password is assigned to the registered message. The assigned password is notified to the sender side via the Internet. The server places the message in the selected basic electronic greeting card to complete a desired electronic greeting card. The sender side informs a recipient (receiver) side of the password and the address (URL) of the server. The recipient side accesses the server via the Internet, and reports the password thereto. The server transmits the message-added desired electronic greeting card to the recipient side via the Internet in response to the reported password. The transmitted electronic greeting card is indicated on a display of recipient's computer.

The Internet-based delivery system has the following problem. To see an electronic greeting card transmitted from a sender side, a recipient side is required to be in an on-line state with respect to the Internet. The recipient side can not see the electronic greeting card when being in an off-line state.

### SUMMARY OF THE INVENTION

It is a first object of this invention to provide an improved digital greeting card.

It is a second object of this invention to provide an improved method of making a digital greeting card.

It is a third object of this invention to provide an improved digital greeting card sales apparatus.

It is a fourth object of this invention to provide an improved method of selling digital greeting cards on a chain basis.

A first aspect of this invention provides a digital greeting card comprising a ROM portion including a first sub portion and a second sub portion, the first sub portion storing signals representing different types of contents, the second sub portion storing a computer program for reproducing the different types of contents and recording information; and an R portion in which segments can be sequentially provided according to the computer program, wherein each of the segments stores a signal designating at least one selected from the different types of contents in accordance with user's request and a signal representative of at least one of (1) a picture, (2) a character sequence, and (3) a sound designed by the user.

A second aspect of this invention is based on the first aspect thereof, and provides a digital greeting card wherein the computer program includes a portion for recording a signal designating at least one selected from the different types of contents and a signal representative of at least one of (1) a picture, (2) a character sequence, and (3) a sound on each of the segments in the R portion.

A third aspect of this invention is based on the first aspect thereof, and provides a digital greeting card wherein the second sub portion stores a security computer program for preventing the different types of contents from being illegally copied.

A fourth aspect of this invention provides a method of making a digital greeting card with a basic card including a ROM portion and an R portion, the ROM portion including a first sub portion and a second sub portion, the first sub portion storing first signals representing different types of contents, the second sub portion storing a computer program for reproducing the different types of contents and recording information. The method comprises the steps of indicating the different types of contents and urging a sender to select one from the different types of contents; generating a second signal designating one among the different types of contents which is selected by the sender; and recording the second signal on the R portion of the basic card to complete a digital greeting card.

A fifth aspect of this invention is based on the fourth aspect thereof, and provides a method further comprising the steps of generating a third signal representative of information about the sender, and recording the third signal on the R portion of the basic card.

A sixth aspect of this invention is based on the fourth aspect thereof, and provides a method further comprising the steps of generating a third signal representative of a message to be transmitted from the sender to a receiver, and recording the third signal on the R portion of the basic card.

A seventh aspect of this invention provides a digital greeting card sales apparatus comprising purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver; charge receiving means for receiving a first charge when the first purchase way is selected, and receiving a second charge higher than the first charge when the second purchase way is selected; contents selecting means for enabling the user to select at least one among different types of contents after the first charge or the second charge is received by the charge receiving means; recording means for recording a signal, which designates the selected one among the different types of contents, on the first and second digital greeting cards to make after-recording digital greeting cards; and card ejecting means for ejecting the after-recording digital greeting cards.

An eighth aspect of this invention is based on the seventh aspect thereof, and provides a digital greeting card sales apparatus further comprising means for recording a signal representative of information about the sender on the first and second digital greeting cards.

A ninth aspect of this invention is based on the seventh aspect thereof, and provides a digital greeting card sales apparatus further comprising means for recording a signal, which represents a massage to be transmitted from the sender to the receiver, on the first and second digital greeting cards.

A tenth aspect of this invention provides a digital greeting card sales apparatus comprising purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver; charge receiving means for receiving a first charge when the first purchase way is selected, and receiving a second charge higher than the first charge when the second purchase way is selected; contents selecting means for enabling the user to select at least one among different types of contents after the first charge or the second charge is received by the charge receiving means; recording means for recording a signal, which designates the selected one among the different types of contents, on the first digital greeting card to make a first after-recording digital greeting card; card ejecting means for ejecting the first after-recording digital greeting card; a communication interface connected to an external apparatus via a communication line; and controlling means for transmitting information about the second digital greeting card and the signal designating the selected one among the different types of contents to the external apparatus via the communication interface, for controlling the external apparatus to make a second after-recording digital greeting card in response to the information about the second digital greeting card and the signal designating the selected one among the different types of contents, and for controlling the external apparatus to eject the second after-recording digital greeting card, the second after-recording digital greeting card storing the signal designating the selected one among the different types of contents.

An eleventh aspect of this invention provides a digital greeting card sales apparatus comprising purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver; charge receiving means for receiving a first charge when the first purchase way is selected, and receiving a second charge higher than the first charge when the second purchase way is selected; contents selecting means for enabling the user to select at least one among different types of contents after the first charge or the second charge is received by the charge receiving means; recording means for recording a signal, which designates the selected one among the different types of contents, on the first digital greeting card to make a first after-recording digital greeting card; card ejecting means for ejecting the first after-recording digital greeting card; a communication interface connected to a server via a communication line; and transmitting means for transmitting information about the second digital greeting card and the signal designating the selected one among the different types of contents to the server via the communication interface.

A twelfth aspect of this invention provides a method of selling digital greeting cards on a chain basis, wherein each of the digital greeting cards comprises a ROM portion including a first sub portion and a second sub portion, the first sub portion storing signals representing different types of contents, the second sub portion storing a computer program for reproducing the different types of contents and recording information; and an R portion in which segments can be sequentially provided according to the computer program, wherein each of the segments stores a signal designating at least one selected from the different types of contents in accordance with user's request and a signal representative of at least one of (1) a picture, (2) a character sequence, and (3) a sound designed by the user. The method comprises the steps of selling a first digital greeting card to a first sender; accepting the first digital greeting card from the first sender and selling a second digital greeting card to the first sender in response to the acceptance of the first digital greeting card, the second digital greeting card being designed to be transmitted to a first receiver; delivering the second digital greeting card to the first receiver; and accepting the second digital greeting card from a second sender being the first receiver and selling a third digital greeting card to the second sender in response to the acceptance of the second digital greeting card, the third digital greeting card being designed to be transmitted to a second receiver.

### BRIEF DESCRIPTION OF THE DRAWINGS

FIG. 1 is a diagram of the format of a recording area of a digital information recording medium (digital greeting card) according to an embodiment of this invention.

FIG. 2 is a diagrammatic front view of a sales apparatus for digital greeting cards according to the embodiment of this invention.

FIG. 3 is a block diagram of the sales apparatus in FIG. 2.

FIG. 4 is a flowchart of a segment of a control program for a controller in FIG. 3.

FIG. 5 is a diagram of various pictures indicated on a display in FIGS. 2 and 3.

FIG. 6 is a diagram of the information recording structures of member cards and digital greeting cards.

FIG. 7 is a diagram of a system including sales apparatuses in the embodiment of this invention.

FIG. 8 is a diagram of member cards and digital greeting cards transmitted among persons.

### DETAILED DESCRIPTION OF THE INVENTION

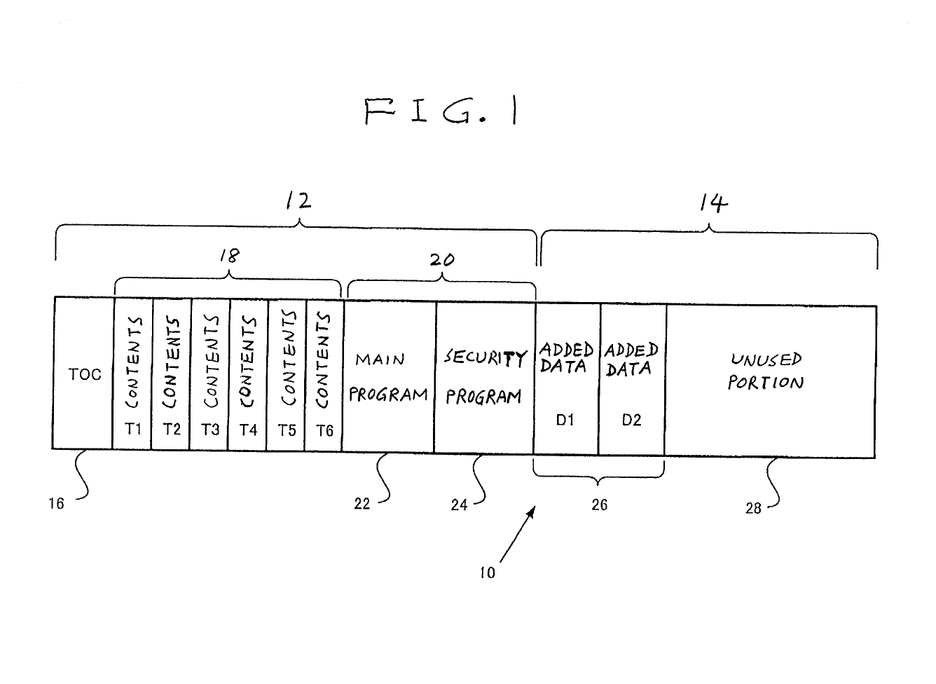

FIG. 1 shows the format of a recording area of a digital information recording medium 10 according to an embodiment of this invention. The digital information recording medium 10 is also referred to as the digital greeting card 10. The digital greeting card 10 can also be used as a member card 10M. Preferably, the digital greeting card 10 is formed by a hybrid CD. The digital green card 10 has a ROM portion 12 and an R (recordable) portion 14. Data are prerecorded on the ROM portion 12. Data can be recorded on the R portion 14.

As shown in FIG. 1, the ROM portion 12 is divided into sub portions 16, 18, and 20. The sub portion 16 stores signals representing a TOC (table of contents). Specifically, the sub portion 16 stores signals representing the addresses of contents data. The tail end of the TOC has a command to read out computer programs from the sub portion 20 immediately after the completion of the read-out of an effective part of the TOC. The sub portion 16 is also referred to as the TOC portion 16. The sub portion 18 stores signals representing template characters and pictures (template character sequences and pictures). Alternatively, the sub portion 18 may store signals (template audio signals) representing template voices or template sounds. The sub portion 18 may store template character/picture signals and template audio signals. In more detail, the sub portion 18 store signals representing different template contents T1-T6 including at least ones of (1) template character sequences, (2) template pictures, and (3) template voices (or template sounds). The sub portion 18 is also referred to as the template contents portion 18. The sub portion 20 stores a main computer program 22 and a fixed security computer program 24. The main computer program 22 is designed to reproduce or play back the template contents T1-T6, and to sequentially write signals representative of messages and other information. The security computer program 24 is designed to prevent the template contents T1-T6 from being illegally copied. The sub portion 20 is also referred to as the program portion 20.

Initially, the R portion 14 is blank or empty. When the digital greeting card 10 is purchased by a sender, the R portion 14 is formed with an additional data recording portion (a write-once data recording portion) 26 storing additionally recorded data which include a signal designating one selected among the template contents T1-T6, a signal representing sender's name, a signal representing recipient's name (receiver's name), and a signal representing a message to be transmitted. The additionally recorded data may further include a signal representing sender's address, a signal representing recipient's address (receiver's address), a signal representing recipient's e-mail address (receiver's e-mail address), a signal representing recipient's telephone number (receiver's telephone number), and a signal representing the date of the purchase of the digital greeting card 10. The template-contents designating signal enables selected one among the template contents T1-T6 to be reproduced or played back. The R portion 14 except the additional data recording portion 26 forms a remaining blank portion or a remaining unused portion 28. In the case where the digital greeting card 10 is formed by a hybrid CD, the total recording capacity thereof is equal to about 19 MB. In this case, the recording capacity of the ROM portion 12 is in the range of 7 to 12 MB, and the remaining recording capacity is assigned to the R portion 14. The additional data recording portion 26 is divided into equally-sized segments loaded with additionally recorded data pieces (for example, written-once data pieces) D1, D2, respectively. Each of the segments has a capacity of 100 KB. Each of the additionally recorded data pieces D1, D2, . . . has a size of 48 KB. Each of the segments includes a 52-KB area loaded with index information and forming an inter-segment guard band. The index information contains an information piece representing the recording order number of a related additionally recorded data piece. For example, the R portion 14 which has a recording capacity of 5 MB is able to store 50 additionally recorded data pieces D1, D2, . . . .

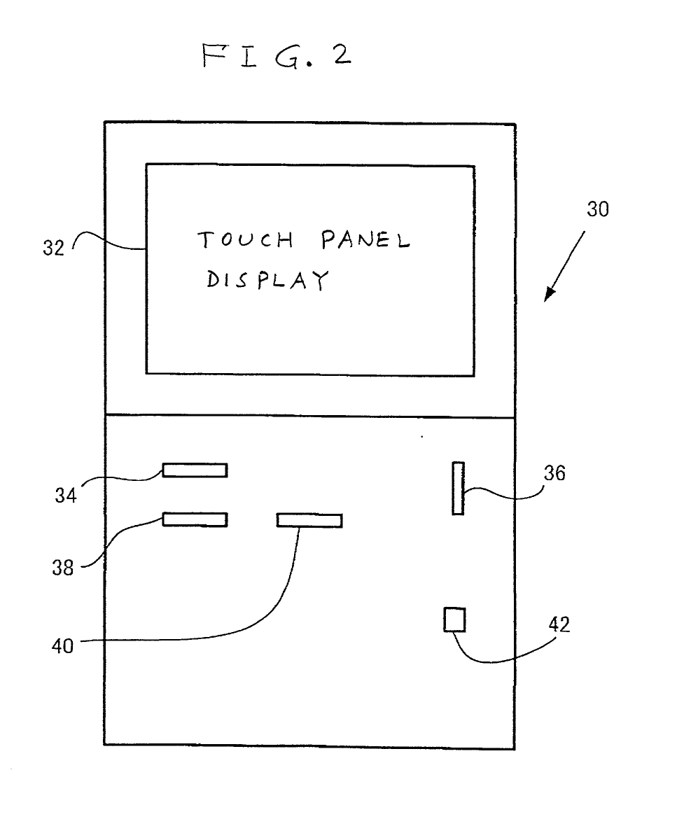

FIG. 2 shows a sales apparatus 30 for digital greeting cards 10 according to the embodiment of this invention. The sales apparatus 30 is located in, for example, a convenience store. A user (sender) can purchase a digital greeting card 10 by operating the sales apparatus 30. The sales apparatus 30 includes a display 32 with a touch panel (touch screen). The sales apparatus 30 further includes a card insertion unit 34, a coin inlet unit 36, card ejection units 38 and 40, and a coin return unit 42.

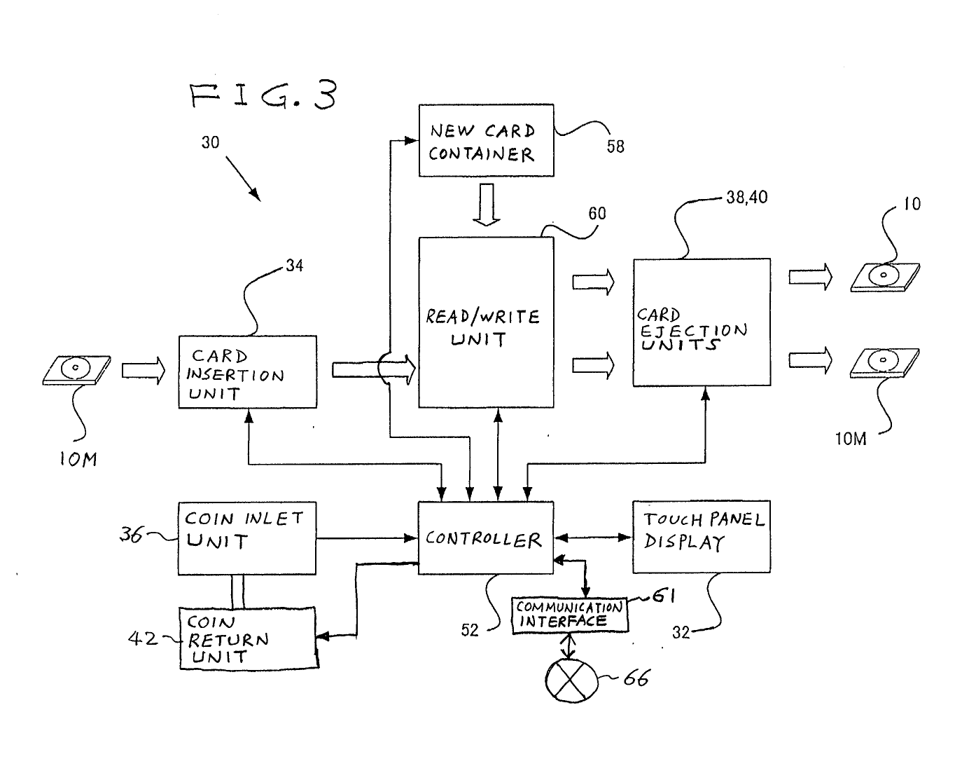

As shown in FIG. 3, the sales apparatus 30 also includes a controller 52, a container unit 58, a read/write unit 60, and a communication interface 61. The controller 52 is connected with the touch-panel-added display 32, the card insertion unit 34, the coin inlet unit 36, the card ejection units 38 and 40, the coin return unit 42, the container unit 58, the read/write unit 60, and the communication interface 61. The controller 52 includes a computer or a similar device having a combination of an input/output port, a CPU, a ROM, and a RAM. The controller 52 may include a drive for a hard disk. The controller 52 operates in accordance with a control program stored in the ROM or the RAM or a control program read out from a member card or a digital greeting card. The control program is designed to enable the controller 52 to implement operation steps mentioned later.

The card insertion unit 34 accepts a member card (a digital greeting card) 10M placed thereinto by a sender or a user. The card insertion unit 34 outputs a signal to the controller 52 which represents the acceptance of the digital greeting card 10M. Accordingly, the card insertion unit 34 acts as a card accepting device. The card insertion unit 34 is provided with a card moving device which transfers the accepted digital greeting card 10M to the read/write unit 60 in response to a command from the controller 52.

The touch-panel-added display 32 indicates various pictures in accordance with commands from the controller 52. The touch panel on the display 32 can be accessed by a user (sender). Signals representing user's commands and user's selection results can be inputted into the controller 52 via the touch panel on the display 32. Accordingly, the touch-panel-added display 32 also acts as a signal inputting device.

The container unit 58 holds a plurality of unused digital greeting cards (new digital greeting cards) 10 in which R portions 14 are fully blank or empty. The container unit 58 is provided with a card moving device which transfers one among the unused digital greeting cards 10 to the read/write unit 60 in response to a command from the controller 52.

The read/write unit 60 receives the digital greeting card 10M from the card insertion unit 34. The read/write unit 60 receives the digital greeting card 10 from the container unit 58. The read/write unit 60 reads out signals from the digital greeting card 10M, and transmits the read-out signals to the controller 52 in accordance with commands from the controller 52. The read/write unit 60 reads out signals from the digital greeting card 10, and transmits the read-out signals to the controller 52 in accordance with commands from the controller 52. The read/write unit 60 writes or records signals on the digital greeting card 10M in accordance with commands from the controller 52. The read/write unit 60 writes or records signals on the digital greeting card 10 in accordance with commands from the controller 52. The read/write unit 60 is provided with card moving devices which transfer the digital greeting cards 10M and 10 to the card ejection units 38 and 40 in response to commands from the controller 52 after the recording of the signals on the digital greeting cards 10M and 10 is completed.

The card ejection units 38 and 40 discharge or output the digital greeting cards 10M and 10 to an exterior in response to commands from the controller 52.

The coin inlet unit 36 receives a coin or coins placed thereinto by a sender or a user. The coin inlet unit 36 includes a sensor for detecting the type of each received coin. The coin inlet unit 36 outputs a signal to the controller 52 which represents the detected type of each received coin. The coin inlet unit 36 further includes a sensor for detecting the number of received coins of each type. The coin inlet unit 36 outputs a signal to the controller 52 which represents the detected number of received coils of each type. The coin inlet unit 36 also includes a sensor for detecting whether each received coin is true or counterfeit. The coin inlet unit 36 is provided with a coin moving device which transfers a counterfeit coin to an outlet of the coin return unit 42.

The coin return unit 42 includes a container for coins. The coin return unit 42 moves a coin or coins from the container to the outlet as change in accordance with a command from the controller 52.

The communication interface 61 is connected with a communication network 66 such as the Internet. The controller 52 can transmit and receive information to and from the Internet 66 via the communication interface 61.

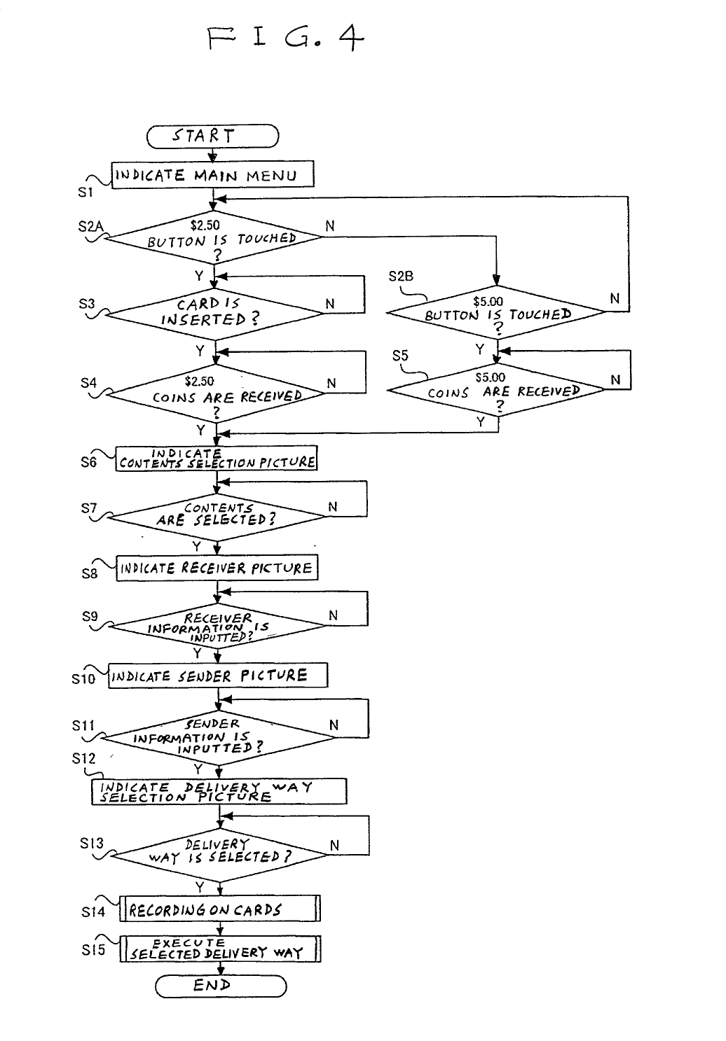

As previously mentioned, the controller 52 operates in accordance with a control program. FIG. 4 is a flowchart of a segment of the control program which is repetitively executed.

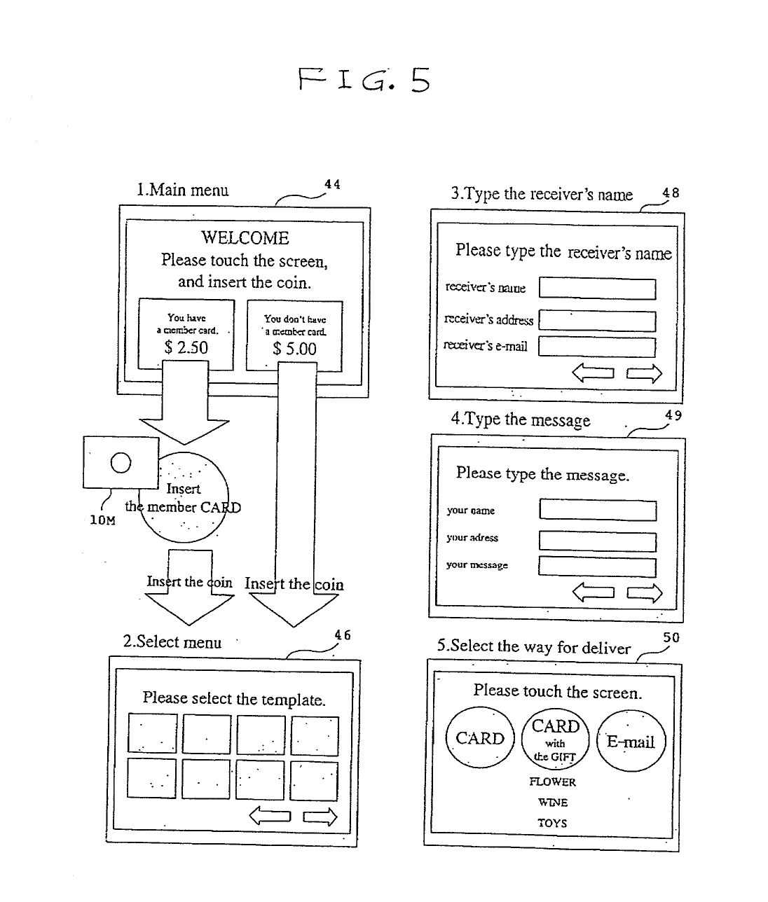

With reference to FIG. 4, a first step S1 of the program segment controls the touch-panel-added display 32 to indicate a main menu picture 44. Data representing the main menu picture 44 are stored in the ROM, the RAM, or the hard disk in the controller 52. As shown in FIG. 5, the main menu picture 44 has a first button area and a second button area. The first button area shows that the price of a card is $2.50 for a user who has a member card. The first button area may have a sentence designed to urge a user to place a user's member card into the card insertion unit 34. The second button area shows that the price of a card is $5.00 for a user who does not have a member card. The main menu picture has a sentence which urges a user to touch corresponding one of the $2.50 button area and the $5.00 button area (the first button area and the second button area). The main menu picture has a sentence designed to urge a user to insert a corresponding coin or coins into the coin inlet unit 36. After the step S1, the program advances to a step S2A.

The step S2A accesses the touch panel in the display 32, and decides whether or not the $2.50 button area is touched. When the $2.50 button area is touched, the program advances from the step S2A to a step S3. Otherwise, the program advances from the step S2A to a step S2B.

The step S3 accesses the card insertion unit 34, and decides whether or not a member card 10M is placed thereinto. When a member card 10M is placed into the card insertion unit 34, the step S3 controls the card insertion unit 34 to transfer the member card 10M to the read/write unit 60. Then, the program advances from the step S3 to a step S4. On the other hand, when a member card 10M is absent from the card insertion unit 34, the step S3 is repeated.

The step S4 accesses the coin inlet unit 36, and decides whether or not coins being $2.50 in total are inserted thereinto. When coins being $2.50 in total are inserted into the coin inlet unit 36, the program advances from the step S4 to a step S6. Otherwise, the step S4 is repeated.

The step S2B accesses the touch panel in the display 32, and decides whether or not the $5.00 button area is touched. When the $5.00 button area is touched, the block S2B controls the container unit 58 to transfer a new digital greeting card 10 to the read/write unit 60. Then, the program advances from the step S2B to a step S5. The new digital greeting card 10 will be used as a member card 10M by a later step or a later block, for example, a later block S14. The member card 10M is assigned to the user (sender). On the other hand, when the $5.00 button area is not touched, the program returns from the step S2B to the step S2A.

The step S5 accesses the coin inlet unit 36, and decides whether or not coins being $5.00 in total are inserted thereinto. When coins being $5.00 in total are inserted into the coin inlet unit 36, the program advances from the step S5 to the step S6.

Otherwise, the step S5 is repeated.

The step S6 controls the touch-panel-added display 32 to indicate a contents selection menu picture 46. Data representing the contents selection menu picture 46 are stored in the ROM, the RAM, or the hard disk in the controller 52. As shown in FIG. 5, the contents selection menu picture 46 has a plurality of button areas showing different templates respectively. The shown templates correspond to the template contents T1-T6, respectively. The contents selection menu picture 46 has a sentence designed to urge a user to touch one among the template button areas to select desired one from the templates (the template contents T1-T6). After the step S6, the program advances to a step S7.

The step S6 may control the read/write unit 60 to read out signals representative of the different templates (the template contents T1-T6) from the member card 10M. In this case, the step S6 processes the read-out signals into data representing the button areas of the contents selection menu picture 46 which show the different templates respectively.

The step S7 accesses the touch panel in the display 32, and decides whether or not one of the template button areas is touched. When one of the template button areas is touched, the program advances from the step S7 to a step S8. Otherwise, the step S7 is repeated. The step S7 detects which of the template button areas is touched, that is, which of the templates is selected by the user. The step S7 generates a signal representing which of the templates is selected by the user. Specifically, the step S7 generates an information signal or a code signal which designates the selected template (the selected template contents).

The step S8 controls the touch-panel-added display 32 to indicate a receiver-related picture (recipient-related picture) 48.

Data representing the receiver-related picture 48 are stored in the ROM, the RAM, or the hard disk in the controller 52. As shown in FIG. 5, the receiver-related picture 48 has blank areas for receiver's name, receiver's address, and receiver's e-mail address. The receiver-related picture 48 may additionally have a blank area for receiver's telephone number. Preferably, the touch-panel-added display 32 or another portion of the sales apparatus 30 is provided with a keyboard which can be actuated by a user. Alternatively, the receiver-related picture 48 may have a keyboard area. Signals representing alphanumeric characters can be inputted into the controller 52 by actuating the keyboard or touching the keyboard area. The receiver-related picture 48 has a sentence designed to urge a user to type receiver's name, receiver's address, and receiver's e-mail address (and also receiver's telephone number) by use of the keyboard or the keyboard area. After the step S8, the program advances to a step S9.

The step S9 decides whether or not signals representing receiver's name, receiver's address, and receiver's e-mail address have been inputted. When signals representing receiver's name, receiver's address, and receiver's e-mail address have been inputted, the program advances from the step S9 to a step S10. Otherwise, the step S9 is repeated.

The step S10 controls the touch-panel-added display 32 to indicate a sender-related picture (user-related picture) 49. Data representing the sender-related picture 49 are stored in the ROM, the RAM, or the hard disk in the controller 52. As shown in FIG. 5, the sender-related picture 49 has blank areas for sender's name (user's name), sender's address (user's address), and a message to be transmitted. The sender-related picture 49 may have a keyboard area. The sender-related picture 49 has a sentence designed to urge a user to type sender's name, sender's address, and a message by use of the keyboard or the keyboard area. After the step S10, the program advances to a step S11.

The step S11 decides whether or not signals representing sender's name, sender's address, and a message have been inputted. When signals representing sender's name, sender's address, and a message have been inputted, the program advances from the step S11 to a step S12. Otherwise, the step S11 is repeated.

The step S12 controls the touch-panel-added display 32 to indicate a card delivery-way selection picture 50. Data representing the card delivery-way selection picture 50 are stored in the ROM, the RAM, or the hard disk in the controller 52. As shown in FIG. 5, the card delivery-way selection picture 50 has first, second, and third button areas assigned to first, second, and third card delivery ways respectively. In the first way, a sender gets a digital greeting card from the sales apparatus 30, and delivers the card to a receiver (a recipient) by hand. In the second way, a digital greeting card with a flower, a bottle of wine, or toys is delivered to a receiver by a home delivery service company. According to the second way, in the case where a receiver is considerably remote from a sender, information representative of a digital greeting card 10 is transmitted via the Internet 66 from the sales apparatus 30 to second sales apparatus in a convenience store near the receiver, and a digital greeting card 10 is outputted from the second sales apparatus 30. Then, the digital greeting card 10 is delivered to the receiver by a home delivery service company. In the third way, an electronic greeting card corresponding to a digital greeting card 10 is registered in a prescribed server, and a sender communicates with a receiver via an e-mail to ask the receiver to access the server and read the electronic greeting card. According to the third way, the server notifies the sender of a password assigned to the registered electronic greeting card, and the sender informs the receiver of the password and the URL of the server via an e-mail. The e-main may contain information about sender's name. The card delivery-way selection picture 50 has a sentence designed to urge a user to touch one among the button areas to select desired one from the first, second, and third card delivery ways. Regarding the second card delivery way, the card delivery-way selection picture 50 has first, second, and third auxiliary button areas assigned to “flower”, “wine”, and “toys” respectively. One among “flower”, “wine”, and “toys” can be selected as a thing to be with a digital greeting card 10 by touching a corresponding auxiliary button area. After the step S12, the program advances to a step S13.

The step S13 accesses the touch panel in the display 32, and decides whether or not one of the delivery-way button areas is touched. When one of the delivery-way button areas is touched, the program advances from the step S13 to a block S14. Otherwise, the step S13 is repeated. The step S13 detects which of the delivery-way button areas is touched, that is, which of the first, second, and third card delivery ways is selected by the user.

The block S14 controls the container unit 58 to transfer a new digital greeting card 10 to the read/write unit 60. The block S14 controls the read/write unit 60 to record or write information on the member card 10M and the new digital greeting card 10. As previously mentioned, the member card 10M has been transferred to the read/write unit 60 from the card insertion unit 34 by the previous step S3 or from the container unit 58 by the previous step S2B. Preferably, the information recorded on the member card 10M by the block S14 is the same as that recorded on the new digital greeting card 10 by the block S14.

A block S15 following the block S14 implements a procedure of executing the selected card delivery way. After the block S15, the current execution cycle of the program segment ends. For example, in the case where the first card delivery way is selected, the block S15 controls the read/write unit 60 to transfer the member card 10M and the digital greeting card 10 to the card ejection units 38 and 40. Then, the block S15 controls the card ejection units 38 and 40 to discharge the member card 10M and the digital greeting card 10.

The information recording block S14 will be described below in more detail. The information recording block S14 controls the read/write unit 60 to read out a main computer program 22 from a new digital greeting card 10. According to the read-out main computer program 22, the information recording block S14 controls the read/write unit 60 to record the information signal or the code signal, which designates the selected template (the selected template contents), on the R portion 14 of the new digital greeting card 10. The selected-template designating signal enables the selected template to be reproduced or played back. In addition, the information recording block S14 controls the read/write unit 60 to record signals representative of sender's name, receiver's name, and a message to be transmitted on the R portion 14 of the new digital greeting card 10. Furthermore, the information recording block S14 may control the read/write unit 60 to record signals representative of sender's address, receiver's address, receiver's e-mail address, and receiver's telephone number on the R portion 14 of the new digital greeting card 10. At that time, the information recording block S14 may control the read/write unit 60 to record a signal of the present date on the R portion 14 of the new digital greeting card 10. Similarly, the information recording block S14 controls the read/write unit 60 to read out a main computer program 22 from the member card 10M. According to the read-out main computer program 22, the information recording block S14 controls the read/write unit 60 to record the information signal or the code signal, which designates the selected template (the selected template contents), on the R portion 14 of the member card 10M. In addition, the information recording block S14 controls the read/write unit 60 to record the signals representative of sender's name, receiver's name, and the message on the R portion 14 of the member card 10M. Furthermore, the information recording block S14 may control the read/write unit 60 to record the signals representative of sender's address, receiver's address, receiver's e-mail address, and receiver's telephone number on the R portion 14 of the member card 10M. At that time, the information recording block S14 may control the read/write unit 60 to record the signal of the present date on the R portion 14 of the member card 10M. Preferably, the information recorded on the R portion 14 of the new digital greeting card 10 is the same as that recorded on the R portion 14 of the member card 10M.

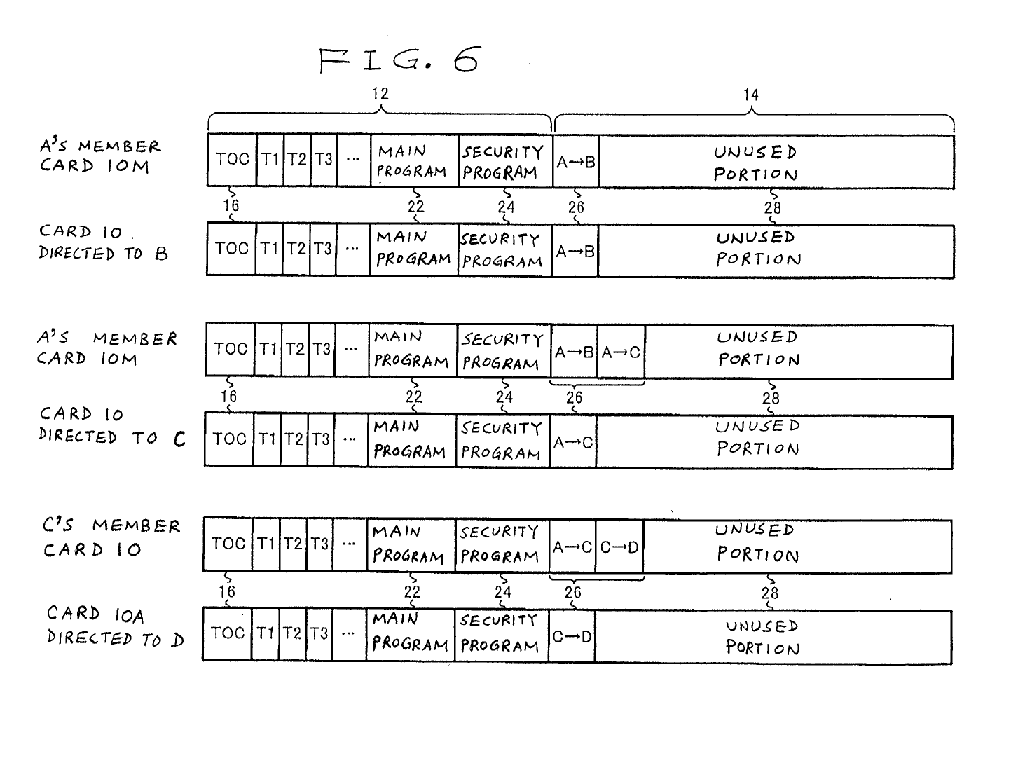

With reference to FIG. 6, a person “A” owns a member card 10M. The person “A” places the member card 10M into the sales apparatus 30 to purchase a digital greeting card 10 designed to be transmitted to a person “B”. When the contents selection menu picture 46 is indicated on the touch-panel-added display 32, the person “A” selects one from the templates (the template contents T1-T6) by touching the display 32. When the receiver-related picture 48 is indicated on the touch-panel-added display 32, the person “A” actuates the keyboard or the keyboard area to input signals representative of B's name, B's address, and B's e-mail address (receiver's name, receiver's address, and receiver's e-mail address) into the sales apparatus 30. When the sender-related picture 49 is indicated on the touch-panel-added display 32, the person “A” actuates the keyboard or the keyboard area to input signals representative of A's name (sender's name), A's address (sender's address), and a message into the sales apparatus 30. The message is designed to be directed to the person “B”. A code signal which designates the selected template (the selected template contents) is recorded on a first part of the R portion 14 of the member card 10M and also a first part of the R portion 14 of the digital greeting card 10 as additionally recorded data “A→B”. Furthermore, a signal representative of the massage to be transmitted to the person “B”, a signal representative of A's name (sender's name), and a signal representative of B's name (receiver's name) are recorded on the first part of the R portion 14 of the member card 10M and the first part of the R portion 14 of the digital greeting card 10 as additionally recorded data “A→B”. The first part of the R portion 14 of the member card 10M occupies a head part of the R portion 14 and constitutes an additional data recording portion (for example, a write-once data recording portion) 26. The first part of the R portion 14 of the digital greeting card 10 occupies a head part of the R portion 14 and constitutes an additional data recording portion (for example, a write-once data recording portion) 26.

After the transmission of the digital greeting card 10 to the person “B”, the person “A” places the member card 10M into the sales apparatus 30 to purchase a digital greeting card 10 designed to be transmitted to a person “C”. When the contents selection menu picture 46 is indicated on the touch-panel-added display 32, the person “A” selects one from the templates (the template contents T1-T6) by touching the display 32. When the receiver-related picture 48 is indicated on the touch-panel-added display 32, the person “A” actuates the keyboard or the keyboard area to input signals representative of C's name, C's address, and C's e-mail address (receiver's name, receiver's address, and receiver's e-mail address) into the sales apparatus 30. When the sender-related picture 49 is indicated on the touch-panel-added display 32, the person “A” actuates the keyboard or the keyboard area to input signals representative of A's name (sender's name), A's address (sender's address), and a message into the sales apparatus 30. The message is designed to be directed to the person “C”. A code signal which designates the selected template (the selected template contents) is recorded on a second part of the R portion 14 of the member card 10M and also a first part of the R portion of the digital greeting card 10 as additionally recorded data “ARC”. Furthermore, a signal representative of the massage to be transmitted to the person “C”, a signal representative of A's name (sender's name), a signal representative of C's name (receiver's name) are recorded on the second part of the R portion 14 of the member card 10M and the first part of the R portion 14 of the digital greeting card 10 as additionally recorded data “ARC”. The second part of the R portion 14 of the member card 10M follows the first part thereof and constitutes the latter half of an expanded additional data recording portion 26. The first part of the R portion 14 of the digital greeting card 10 occupies a head part of the R portion 14 and constitutes an additional data recording portion 26.

After receiving the digital greeting card 10, the person “C” uses the same card 10 as a member card 10 and places the member card 10 into the sales apparatus 30 to purchase a digital greeting card 10A designed to be transmitted to a person “D”. When the contents selection menu picture 46 is indicated on the touch-panel20 added display 32, the person “C” selects one from the templates (the template contents T1-T6) by touching the display 32. When the receiver-related picture 48 is indicated on the touch-panel-added display 32, the person “C” actuates the keyboard or the keyboard area to input signals representative of D's name, D's address, and D's e-mail address (receiver's name, receiver's address, and receiver's e-mail address) into the sales apparatus 30. When the sender-related picture 49 is indicated on the touch-panel-added display 32, the person “C” actuates the keyboard or the keyboard area to input signals representative of C's name (sender's name), C's address (sender's address), and a message into the sales apparatus 30. The message is designed to be directed to the person “D”. A code signal which designates the selected template (the selected template contents) is recorded on a second part of the R portion 14 of the member card 10 and also a first part of the R portion of the digital greeting card 10A as additionally recorded data “C→D”. Furthermore, a signal representative of the massage to be transmitted to the person “D”, a signal representative of C's name (sender's name), and a signal representative of D's name (receiver's name) are recorded on the second part of the R portion 14 of the member card 10 and the first part of the R portion 14 of the digital greeting card 10A as additionally recorded data “CAD”. The second part of the R portion 14 of the member card 10 follows the first part thereof and constitutes the latter half of an expanded additional data recording portion 26. The first part of the R portion 14 of the digital greeting card 10A occupies a head part of the R portion 14 and constitutes an additional data recording portion 26.

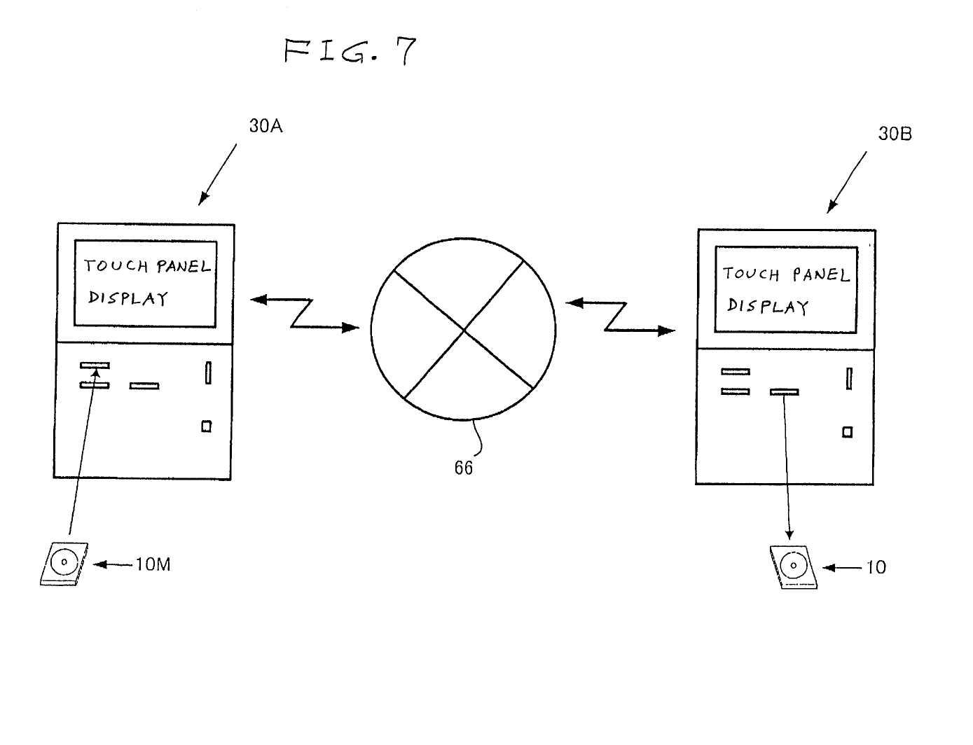

FIG. 7 shows a system including sales apparatuses 30A and 30B in the embodiment of this invention. Each of the sales apparatuses 30A and 30B is similar to the sales apparatus 30. The sales apparatuses 30A and 30B can be connected to each other via the Internet 66. A sender places a member card 10M into the sales apparatus 30A to purchase a digital greeting card 10. It is assumed that the sender selects the second card delivery way when the card delivery-way selection picture 50 is indicated on the touch-panel-added display 32 of the sales apparatus 30A. In this case, the sales apparatus 30A does not discharge a digital greeting card 10. The sales apparatus 30A transmits data representative of a digital greeting card 10 to the sales apparatus 30B via the Internet 66. In addition, the sales apparatus 30A transmits, to the sales apparatus 30B, a signal representing a command to make a digital greeting card on the basis of the transmitted data representative thereof. The sales apparatus 30B responds to the command, and thereby generates a digital greeting card 10 in accordance with the data transmitted from the sales apparatus 30A. The sales apparatus 30B discharges the digital greeting card 10. Then, the digital greeting card 10 is delivered to a receiver by a home delivery service company.

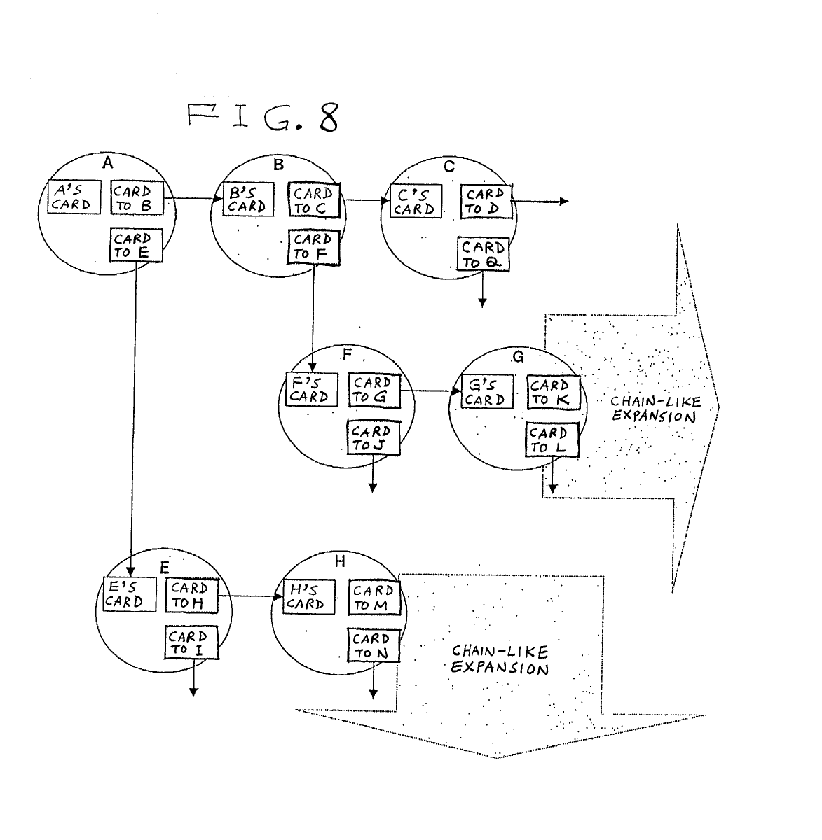

With reference to FIG. 8, at an initial stage, a person “A” owns a member card (a digital greeting card). The person “A” places the A's member card into a sales apparatus 30 to purchase a digital greeting card to be transmitted to a person “B”. The digital greeting card is delivered to the person “B”. The person “A” places the A's member card into the sales apparatus 30 to purchase a digital greeting card to be transmitted to a person “E”. The digital greeting card is delivered to the person “E”.

The person “B” uses the delivered digital greeting card as a B's member card. The person “B” places the B's member card into a sales apparatus 30 to purchase a digital greeting card to be transmitted to a person “C”. The digital greeting card is delivered to the person “C”. The person “B” places the B's member card into the sales apparatus 30 to purchase a digital greeting card to be transmitted to a person “F”. The digital greeting card is delivered to the person “F”.

The person “C” uses the delivered digital greeting card as a C's member card. The person “C” places the C's member card into a sales apparatus 30 to purchase a digital greeting card to be transmitted to a person “D”. The digital greeting card is delivered to the person “D”. The person “C” places the C's member card into the sales apparatus 30 to purchase a digital greeting card to be transmitted to a person “Q”. The digital greeting card is delivered to the person “Q”.

The person “F” uses the delivered digital greeting card as an F's member card. The person “F” places the F's member card into a sales apparatus 30 to purchase a digital greeting card to be transmitted to a person “G”. The digital greeting card is delivered to the person “G”. The person “F” places the F's member card into the sales apparatus 30 to purchase a digital greeting card to be transmitted to a person “J”. The digital greeting card is delivered to the person “J”.

The person “G” uses the delivered digital greeting card as a G's member card. The person “G” places the G's member card into a sales apparatus 30 to purchase a digital greeting card to be transmitted to a person “K”. The digital greeting card is delivered to the person “K”. The person “G” places the G's member card into the sales apparatus 30 to purchase a digital greeting card to be transmitted to a person “L”. The digital greeting card is delivered to the person “L”.

The person “E” uses the delivered digital greeting card as an E's member card. The person “E” places the E's member card into a sales apparatus 30 to purchase a digital greeting card to be transmitted to a person “H”. The digital greeting card is delivered to the person “H”. The person “E” places the E's member card into the sales apparatus 30 to purchase a digital greeting card to be transmitted to a person “I”. The digital greeting card is delivered to the person “I”.

The person “H” uses the delivered digital greeting card as an H's member card. The person “H” places the H's member card into a sales apparatus 30 to purchase a digital greeting card to be transmitted to a person “M”. The digital greeting card is delivered to the person “M”. The person “H” places the H's member card into the sales apparatus 30 to purchase a digital greeting card to be transmitted to a person “N”. The digital greeting card is delivered to the person “N”.

As shown in FIG. 8, digital greeting cards are transmitted among persons on a chain-like expansive basis. The transmission of each digital greeting card between two persons is in one selected from the first, second, and third card delivery ways.

A receiver (recipient) gets a digital greeting card 10 transmitted from a sender. The receiver places the digital greeting card 10 into a CD drive of receiver's personal computer. Firstly, the CD drive accesses the TOC portion 16 of the digital greeting card 10, and reads out signals representative of a TOC therefrom. The CD drive notifies the TOC to a main portion of the receiver's personal computer. As previously mentioned, the tail end of the TOC has a command to read out computer programs from the sub portion 20 of the digital greeting card 10 immediately after the completion of the read-out of an effective part of the TOC. In response to this command, the CD drive reads out a main computer program 22 and a fixed security computer program 24 from the sub portion 20 of the digital greeting card 10. The main computer program 22 and the fixed security computer program 24 are transferred from the CD drive to a memory within the main portion of the receiver's personal computer. According to the main computer program 22, the main portion of the receiver's personal computer controls the CD drive to read out additionally recorded data from the additional data recording portion 26 of the digital greeting card 10. When the digital greeting card 10 has the internal structure shown in FIG. 1, the CD drive is controlled to read out only the last additionally recorded data piece D2 from the additional data recording portion 26 of the digital greeting card 10. The additionally recorded data piece D2 is transferred from the CD drive to the main portion of the receiver's personal computer. According to the main computer program 22, the main portion of the receiver's personal computer controls a display thereof to indicate the additionally recorded data piece D2. The additionally recorded data piece D2 includes a signal representative of a selected template (selected template contents), a signal representative of sender's name, a signal representative of receiver's name, and a signal representative of a message. Therefore, the selected template (the selected greeting card template) is indicated on the display while the sender's name, the receiver's name, and the massage are indicated and superimposed over the indicated template. Preferably, the CD drive is prohibited from reading out the former additionally recorded data piece D1 from the additional data recording portion 26 of the digital greeting card 10. The sales apparatus 30 may be provided with a suitable device for inputting a signal representative of a picture-added message, a voice-added message, a sound-added message, a picture-voice-added message, or a picture-sound-added message into the controller 52. In this case, the sales apparatus 30 can record a signal representative of a picture-added message, a voice-added message, a sound-added message, a picture-voice-added message, or a picture-sound-added message on the R portions 14 of a member card 10M and a digital greeting card 10. In a receiver side (recipient side), picture and character portions of a message are indicated on the display of the receiver's personal computer while sound or voice portions thereof are reproduced by a loudspeaker of the receiver's personal computer. The recording of information on the R portion 14 of a digital greeting card 10 (or a member card 10M) is implemented according to a main computer program 22 read out from the sub portion 20 of the digital greeting card 10 (or the member card 10M). Thus, it is difficult to alter the information recorded on the R portion 14 of the digital greeting card 10 with using a computer program different from the main computer program 22.

In the case where a sender selects the third card delivery way, a sales apparatus 30 registers an electronic greeting card in a prescribed server via the Internet 66. The electronic greeting card corresponds to a digital greeting card 10, and thus includes a signal representative of a message made by the sender and also a signal designating one selected among the templates (the template contents T1-T6) by the sender. The server returns a signal representative of a password to the sales apparatus 30 via the Internet 66. The password is assigned to the registered electronic greeting card. The sales apparatus 30 notifies the sender of the password and also the URL of the server. The sender informs the receiver of the password and the URL of the server via an e-mail. The receiver side accesses the server via the Internet, and reports the password thereto. The server transmits the electronic greeting card to the receiver side via the Internet in response to the reported password. The transmitted electronic greeting card is indicated on a display of receiver's personal computer. The indicated greeting card has the template (the template contents) selected by the user and also the message made by the sender.

A digital greeting card 10 or a member card 10M may be formed by a semiconductor memory, a magneto-optical recording medium, or an IC-based recording medium.

What is claimed is:

1. A digital greeting card comprising:
a ROM portion including a first sub portion and a second sub portion, the first sub portion storing signals representing different types of contents, the second sub portion storing a computer program for reproducing the different types of contents and recording information; and
an R portion in which segments can be sequentially provided according to the computer program, wherein each of the segments stores a signal designating at least one selected from the different types of contents in accordance with user's request and a signal representative of at least one of (1) a picture, (2) a character sequence, and (3) a sound designed by the user.

2. A digital greeting card as recited in claim 1, wherein the computer program includes a portion for recording a signal designating at least one selected from the different types of contents and a signal representative of at least one of (1) a picture, (2) a character sequence, and (3) a sound on each of the segments in the R portion.

3. A digital greeting card as recited in claim 1, wherein the second sub portion stores a security computer program for preventing the different types of contents from being illegally copied.

4. A method of making a digital greeting card with a basic card including a ROM portion and an R portion, the ROM portion including a first sub portion and a second sub portion, the first sub portion storing first signals representing different types of contents, the second sub portion storing a computer program for reproducing the different types of contents and recording information, the method comprising the steps of:
indicating the different types of contents and urging a sender to select one from the different types of contents;
generating a second signal designating one among the different types of contents which is selected by the sender; and
recording the second signal on the R portion of the basic card to complete a digital greeting card.

5. A method as recited in claim 4, further comprising the steps of generating a third signal representative of information about the sender, and recording the third signal on the R portion of the basic card.

6. A method as recited in claim 4, further comprising the steps of generating a third signal representative of a message to be transmitted from the sender to a receiver, and recording the third signal on the R portion of the basic card.

7. A digital greeting card sales apparatus comprising:
purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver;
charge receiving means for receiving a first charge when the first purchase way is selected, and receiving a second charge higher than the first charge when the second purchase way is selected;
contents selecting means for enabling the user to select at least one among different types of contents after the first charge or the second charge is received by the charge receiving means;
recording means for recording a signal, which designates the selected one among the different types of contents, on the first and second digital greeting cards to make after-recording digital greeting cards; and
card ejecting means for ejecting the after-recording digital greeting cards.

8. A digital greeting card sales apparatus as recited in claim 7, further comprising means for recording a signal representative of information about the sender on the first and second digital greeting cards.

9. A digital greeting card sales apparatus as recited in claim 7, further comprising means for recording a signal, which represents a massage to be transmitted from the sender to the receiver, on the first and second digital greeting cards.

10. A digital greeting card sales apparatus comprising:
purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver;
charge receiving means for receiving a first charge when the first purchase way is selected, and receiving a second charge higher than the first charge when the second purchase way is selected;
contents selecting means for enabling the user to select at least one among different types of contents after the first charge or the second charge is received by the charge receiving means;
recording means for recording a signal, which designates the selected one among the different types of contents, on the first digital greeting card to make a first after-recording digital greeting card;
card ejecting means for ejecting the first after-recording digital greeting card;
a communication interface connected to an external apparatus via a communication line; and
controlling means for transmitting information about the second digital greeting card and the signal designating the selected one among the different types of contents to the external apparatus via the communication interface, for controlling the external apparatus to make a second after-recording digital greeting card in response to the information about the second digital greeting card and the signal designating the selected one among the different types of contents, and for controlling the external apparatus to eject the second after-recording digital greeting card, the second after-recording digital greeting card storing the signal designating the selected one among the different types of contents.

11. A digital greeting card sales apparatus comprising:
purchase-way selecting means for enabling a sender to select one from a first purchase way and a second purchase way, the first purchase way being that the sender owns a first digital greeting card and uses the first digital greeting card to purchase a second digital greeting card to be transmitted to a receiver, the second purchase way being that the sender purchases both a first digital greeting card assigned to the sender and a second digital greeting card to be transmitted to a receiver;
charge receiving means for receiving a first charge when the first purchase way is selected, and receiving a second charge higher than the first charge when the second purchase way is selected;
contents selecting means for enabling the user to select at least one among different types of contents after the first charge or the second charge is received by the charge receiving means;
recording means for recording a signal, which designates the selected one among the different types of contents, on the first digital greeting card to make a first after-recording digital greeting card;
card ejecting means for ejecting the first after-recording digital greeting card;
a communication interface connected to a server via a communication line; and
transmitting means for transmitting information about the second digital greeting card and the signal designating the selected one among the different types of contents to the server via the communication interface.

12. A method of selling digital greeting cards on a chain basis, wherein each of the digital greeting cards comprises a ROM portion including a first sub portion and a second sub portion, the first sub portion storing signals representing different types of contents, the second sub portion storing a computer program for reproducing the different types of contents and recording information; and an R portion in which segments can be sequentially provided according to the computer program, wherein each of the segments stores a signal designating at least one selected from the different types of contents in accordance with user's request and a signal representative of at least one of (1) a picture, (2) a character sequence, and (3) a sound designed by the user, the method comprising the steps of:
selling a first digital greeting card to a first sender;
accepting the first digital greeting card from the first sender and selling a second digital greeting card to the first sender in response to the acceptance of the first digital greeting card, the second digital greeting card being designed to be transmitted to a first receiver;
delivering the second digital greeting card to the first receiver; and
accepting the second digital greeting card from a second sender being the first receiver and selling a third digital greeting card to the second sender in response to the acceptance of the second digital greeting card, the third digital greeting card being designed to be transmitted to a second receiver.
